(19) United States
(12) Patent Application Publication
(10) Pub. No.: US 2010/0177518 A1
(43) Pub. Date: Jul. 15, 2010

(54) LONG-PASS OPTICAL FILTER MADE FROM NANOFIBERS

(75) Inventors: Howard J. Walls, Apex, NC (US); James Lynn Davis, Holly Springs, NC (US); David S. Ensor, Chapel Hill, NC (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: RESEARCH TRIANGLE INSTITUTE, RESEARCH TRIANGLE PARK, NC (US)

(21) Appl. No.: 12/602,607

(22) PCT Filed: Jun. 12, 2008
(86) PCT No.: PCT/US08/66620

§ 371 Date: Dec. 1, 2009

Related U.S. Application Data
(60) Provisional application No. 60/929,077, filed on Jun. 12, 2007.

(51) Int. Cl. F21V 9/00; G02B 5/20; G02B 5/26

(52) U.S. Cl. 362/293; 359/885; 359/839

(57) ABSTRACT

An optical device having a mat including plural nanofibers configured to transmit light having wavelengths above a cutoff wavelength and to reject light at wavelengths below the cutoff wavelength. The nanofibers have an average fiber diameter comparable in size to the cutoff wavelength.

### CROSS REFERENCE TO RELATED APPLICATIONS

This application is related to U.S. application Ser. No. 10/819,916, filed on Apr. 8, 2004, entitled “Electrospinning of Polymer Nanofibers Using a Rotating Spray Head,” Attorney Docket No. 241015US-2025-2025-20, the entire contents of which are incorporated herein by reference. This application is also related to U.S. application Ser. No. 10/819,942, filed on Apr. 8, 2004, entitled “Electrospray/electrospinning Apparatus and Method,” Attorney Docket No. 241013US-2025-2025-20, the entire contents of which are incorporated herein by reference. This application is related to U.S. application Ser. No. 10/819,945, filed Apr. 8, 2004, entitled “Electrospinning in a Controlled Gaseous Environment,” Attorney Docket No. 245016US-2025-2025-20, the entire contents of which are incorporated herein by reference. This application is related to U.S. Ser. No. 11/130,269, filed May 17, 2005 entitled “Nanofiber Mats and Production Methods Thereof,” Attorney Docket No. 256964US-2025-2025-20, the entire contents of which are incorporated herein by reference. This application is related to U.S. Ser. No. 11/559,282 filed Nov. 13, 2006 entitled “Particle Filter System Incorporating Nanofibers,” Attorney Docket No. 283730US-2025-2025-20, the entire contents of which are incorporated herein by reference. This application is related to U.S. Ser. No. 11/559,260 filed Nov. 13, 2006 entitled “Luminescent Device,” Attorney Docket No. 289033US-2025-2025-20, the entire contents of which are incorporated herein by reference.

### STATEMENT REGARDING FEDERALLY SPONSORED RESEARCH

The present invention was made in part with U.S. Government support under Department of Energy Grant No. DE-FC26-06NT42861. The U.S. Government may have certain rights to this invention.

### BACKGROUND OF THE INVENTION

1. Field of the Invention

The present invention relates to nanofiber based optical elements and methods for making such elements.

2. Discussion of the Background

The choice of general illumination sources for commercial and residential lighting is generally governed by a balance of energy efficiency and the ability to faithfully produce colors as measured by the color rendering index (CRI). Existing fluorescent lighting is known to be economical from an energy consumption point of view. However, many users complain that the light produced by the existing fluorescent lighting is of poor spectral quality and produces eye strain and other adverse health effects. Incandescent light is also widely used and is recognized as having excellent spectral quality and the ability to accurately render colors. This high spectral quality is derived from the hot filament, which serves as a blackbody radiator and emits light over many wavelengths, similar to the sun. However, incandescent lighting suffers from very low energy efficiency. Thus, there is a long felt need to produce light sources that use less energy and have a light composition similar to the composition of the sun light.

Solid-state lighting (SSL) is an alternative general illumination and lighting technology that promises the energy efficiency of fluorescent lights and the excellent spectral qualities of incandescent lighting. Typically, commercially available SSL technologies consists of a light emitting diode (LED) surrounded by a phosphor composed of large particles usually larger than 2 μm. The light emitted from the LED is of sufficient energy to cause the phosphor to fluoresce and emit one or more colors of visible light. The most common example of commercial SSL products consists of a blue LED (typically 460 nm) surrounded by a yellow phosphor, such as cerium-doped yttrium aluminum garnet (YAG:Ce), that emits lights in a broad band centered at 550 nm. The combination of the yellow light emission from the phosphor and blue light from the LED produces a light source that has a generally white appearance. Alternatively, an LED that emits in the ultraviolet (<400 nm) can be used to excite a blend of red, green, and blue phosphors. While this approach produces white light, it suffers from low efficiency and poor spectral quality due to the limited number of wavelengths.

In addition, there are currently no known commercial technologies that provide for preferential light scatting of the pump wavelength used in phosphor converted light emitting diodes pc-LEDs. All commercial white LEDs exhibit a significant bleed through of the pump wavelength, which results in (1) a blue tint to the white light, (2) low efficiency, and (3) a high correlated color temperature (CCT) (aka, “cool white”).

Background work in this field is described in more detail in the following references. The entire contents of each reference are incorporated herein by reference.

1. U.S. Pat. No. 5,686,979, entitled Optical panel capable of switching between reflective and transmissive states.

2. U.S. Pat. No. 5,882,774 entitled Optical film.

3. M. F. Weber et al., Giant birefringent optics in multilayer polymer mirrors, Science 287 (2000) page 2451.

4. U.S. Pat. No. 7,091,653 entitled Phosphor based light sources having a non-planar long pass reflector.

5. U.S. Pat. Appl. No. 2006-0194046 entitled Polymer photonic crystal fibers.

6. U.S. Pat. Appl. Publ. No. 2006-0193582 entitled Composite polymer fibers.

7. U.S. Pat. Appl. Publ. No. 2006-0194487 entitled Optical elements containing a polymer fiber weave.

8. U.S. Pat. No. 7,118,438 entitled Methods of making phosphor based light sources having an interference reflector.

9. U.S. Pat. No. 7,157,839 entitled Phosphor based light sources utilizing total internal reflection.

### SUMMARY OF THE INVENTION

In one embodiment of the present invention, there is provided an optical device having a mat including plural nanofibers configured to transmit light having wavelengths above a cutoff wavelength and to reject light at wavelengths below the cutoff wavelength. The nanofibers have an average fiber diameter comparable in size to the cutoff wavelength.

In one embodiment of the present invention, there is provided a method for making the optical device and the nanofibers therein.

It is to be understood that both the foregoing general description of the invention and the following detailed description are exemplary, but are not restrictive of the invention.

### BRIEF DESCRIPTION OF THE DRAWINGS

A more complete appreciation of the present invention and many attendant advantages thereof will be readily obtained as the same becomes better understood by reference to the following detailed description when considered in connection with the accompanying drawings, wherein:

FIG. 1A is an optical micrograph of a PMMA nanofiber structure, according to one embodiment of the present invention;

FIG. 1B is a scanning electron micrograph of a PMMA nanofiber structure showing a pore structure according to one embodiment of the present invention;

FIG. 2A is an optical micrograph of a PMMA nanofiber structure in contrast to FIG. 1A;

FIGS. 2B and 2C are scanning electron micrographs of PMMA nanofiber structures electrospun under differing humidity levels;

FIG. 3 is a schematic illustration depicting an electrospinning apparatus suitable for deposition of fibers and/or nanofibers of the present invention

FIG. 4A is graph, according to one embodiment of the present invention, showing how the optical transmission of a nano-fiber based optical element varies across the visible spectrum;

FIG. 4B is graph, according to one embodiment of the present invention, showing how the peak optical transmission of a nano-fiber based optical element varies across the visible spectrum;

FIG. 5 is a graph, according to one embodiment of the present invention, showing how the optical transmission of a nano-fiber based optical element can be reduced across the visible spectrum;

FIG. 6 is a schematic illustrating an effect that relative humidity has on the resultant optical scatter; and

FIG. 7 is a schematic illustrating an optical filter of the present invention having a relatively flat transmission response in certain spectral regions.

### DETAILED DESCRIPTION OF THE EMBODIMENTS

This invention is related to an optical structure made from electrospun nanofibers that exhibits wavelength dependent extinction of light due to preferential light scattering. In one embodiment of the present invention, by controlling the morphology (i.e., diameter, porosity, and density), an optical structure is created that exhibits a low transmittance (i.e., high extinction coefficient) for certain wavelengths and a much higher transmittance (i.e., lower extinction coefficient) for longer wavelengths. This optical structure can be used as a long-pass optical filter to block the transmission of wavelengths (e.g., UV) below a predetermined cut-off value (termed passband). This structure can also be used as a wavelength-dependent reflector to reflect wavelengths below a predetermined cut-off value.

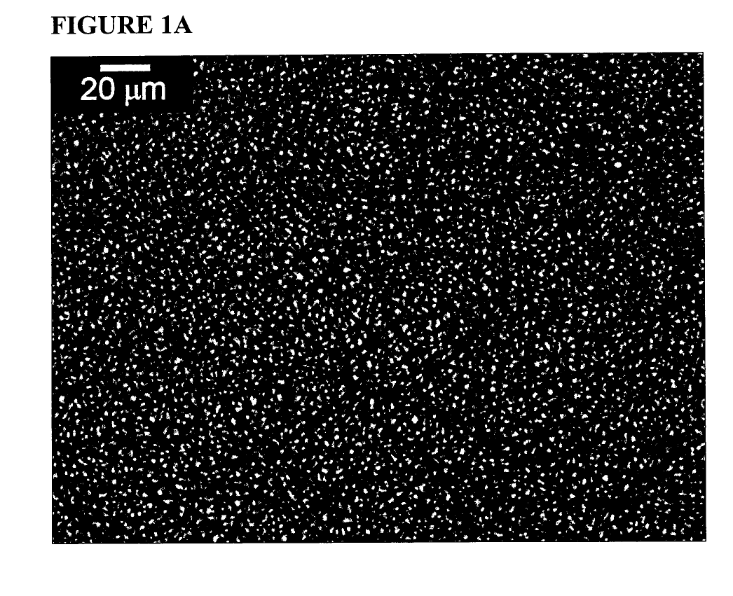

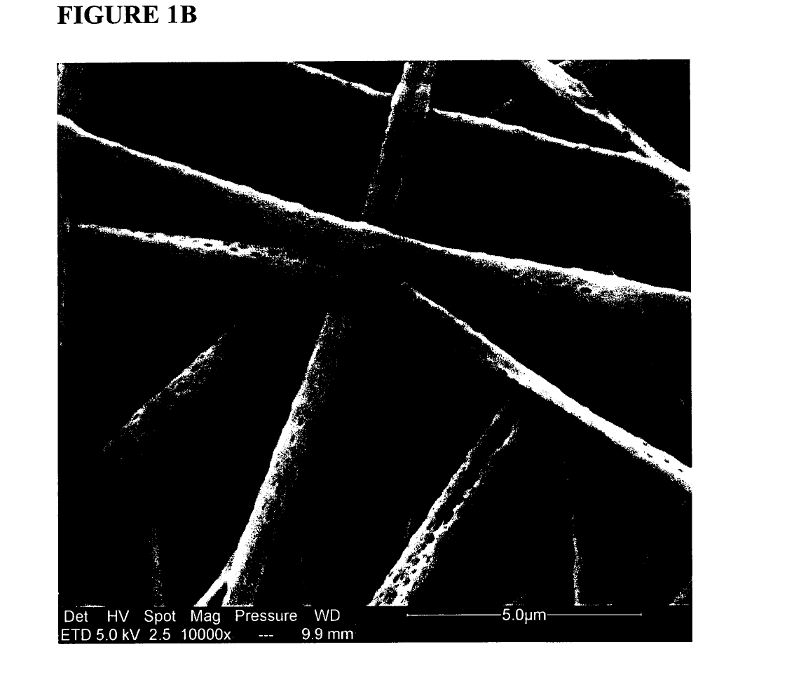

Accordingly, nanofibers of a proper morphology and diameter can be effective scatterers of visible radiation. For a non-absorbing polymer such as polymethyl(methacrylate), the fiber diameter, fiber shape, and relative spacing between adjacent fibers is one factor to be engineered. For example, the PMMA nanofiber structure shown in FIG. 1A will exhibit good optical scattering properties because the nanofibers are uniformly coated across the nanofiber structure. For fiber mats in which the fibers are evenly distributed such that the fibers are not agglomerated in groups and the spacing between adjacent fibers is consistent, the scattering effects at shorter wavelengths are prominent. When the fibers are bunched together or when there are gaps in the fiber coating, the scattering effects are diminished.

More specifically, FIG. 1A is an optical micrograph of a PMMA nanofiber structure including nanofibers that are porous, ribbon-shaped materials. Porosity refers to the small features on the surface of the nanofiber ribbon. These features are confined to the surface and do not go through the fiber. The size of these features is less than 50 nm. This structure was created by electrospinning in a controlled humidity environment (for example, but not restrictive to 30% to 40% relative humidity (RH)) with a blanket gas of CO₂. FIG. 1B is a scanning electron micrograph of a PMMA nanofiber structure showing a pore structure according to one embodiment of the present invention.

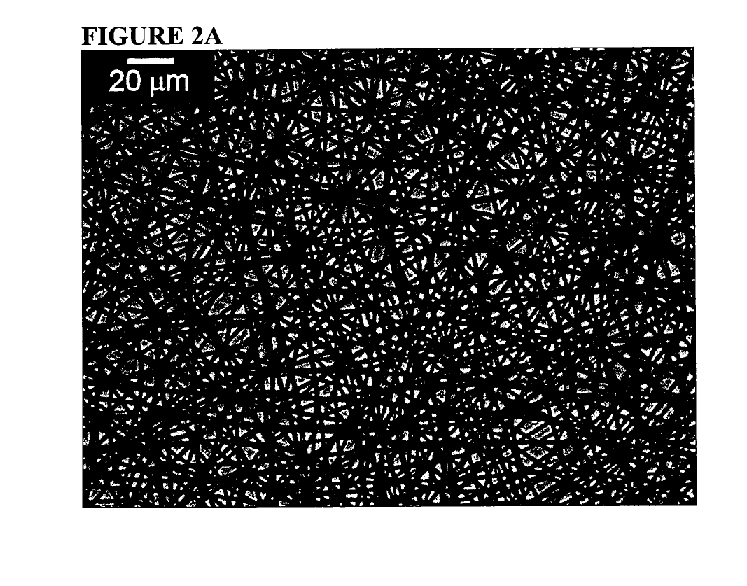

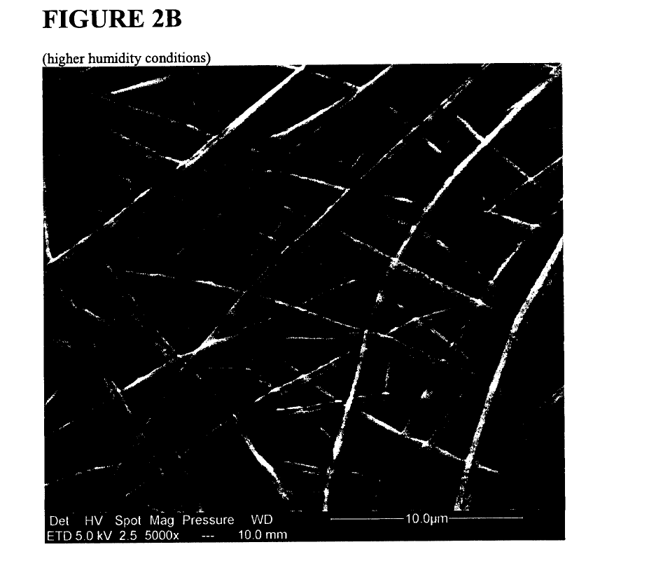

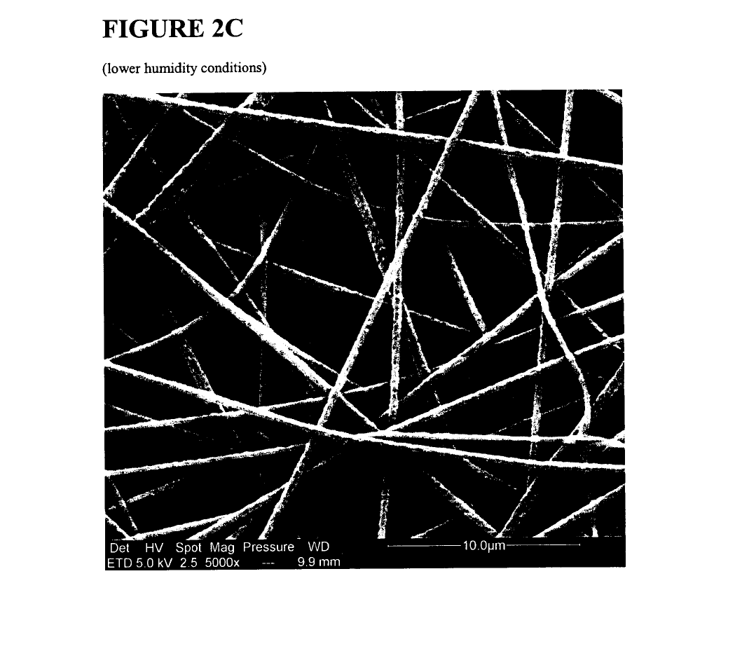

When the fibers are bunched together or when there are gaps in the fiber coating, producing uneven coatings of nanofibers, which result in voids in the nanofiber structure or clustering of individual nanofibers, the effect of scattering at shorter wavelengths are diminished. Such a structure is shown in FIG. 2A. More specifically, FIG. 2A is an optical micrograph of a PMMA nanofiber structure with poor light scattering properties. While the nanofibers are also porous and ribbon-shaped materials (as illustrated in FIG. 1B), there are gaps in filter coverage and regions where the nanofibers in turn are agglomerated. This structure was created by electrospinning in a low humidity environment (<30% RH) with a blanket gas of CO₂. FIGS. 2B and 2C shows an SEM micrograph illustrating this effect. FIG. 2C shows under the lower humidity conditions that the fibers have a tendency to agglomerate leaving voids in the fiber coverage.

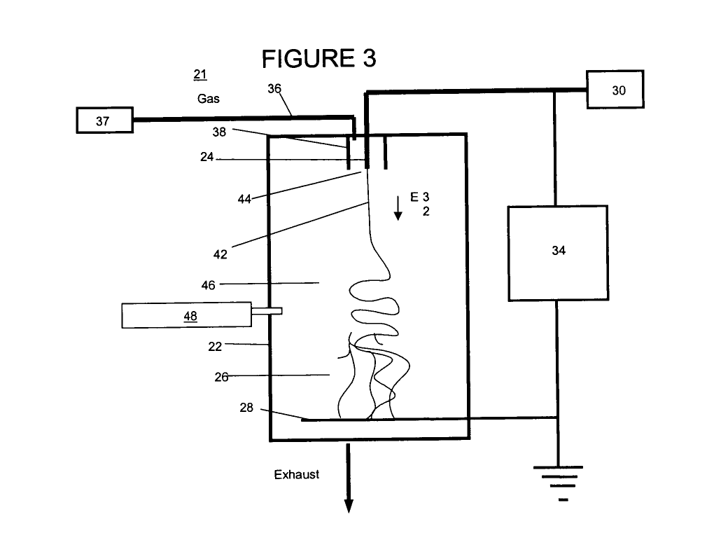

FIG. 3 is a schematic illustration depicting an electrospinning apparatus suitable for deposition of fibers and/or nanofibers of the present invention. In FIG. 3, an electrospinning apparatus 21 includes a chamber 22 surrounding an electrospinning element 24. As such, the electrospinning element 24 is configured to electrospin a substance from which fibers are composed to form fibers 26. The electrospinning apparatus 21 includes a collector 28 disposed from the electrospinning element 24 and configured to collect the fibers and/or nanofibers. Various methods for forming fibers and nanofibers are described in U.S. Ser. Nos. 10/819,942, 10/819,945, and 10/819,916 listed and incorporated by reference above.

The electrospinning element 24 communicates with a reservoir supply 30 containing the electrospray medium such as for example the above-noted polymer solution. The electrospray medium of the present invention includes polymer solutions and/or melts known in the art for the extrusion of fibers including extrusions of nanofiber materials. Indeed, polymers and solvents suitable for the present invention include for example polystyrene in dimethylformamide or toluene, polycaprolactone in dimethylformamide/methylene chloride mixture, poly(ethyleneoxide) in distilled water, poly(acrylic acid) in distilled water, poly(methyl methacrylate) PMMA in toluene, cellulose acetate in acetone, polyacrylonitrile in dimethylformamide, polylactide in dichloromethane or dimethylformamide, and poly(vinylalcohol) in distilled water and combinations thereof. In general, suitable solvents for the present invention include both organic and inorganic solvents in which polymers can be dissolved. The polymer materials when formed are preferably transparent materials, although the polymers may be spun with additives that act as color filters for the luminescent compounds.

A high voltage source 34 is provided to maintain the electrospinning element 24 at a high voltage. The collector 28 is placed preferably 1 to 100 cm away from the tip of the electrospinning element 24. The collector 28 can be a plate or a screen. Typically, an electric field strength between 2,000 and 400,000 V/m is established by the high voltage source 34. Typically, the collector 28 is grounded, and the fibers 26 produced by electrospinning from the electrospinning elements 24 are directed by the electric field 32 toward the collector 28. The electric field 32 pulls the substance from which the fiber is to be composed as a filament or liquid jet 42 of fluid from the tip of the electrospinning element 24. A supply of the substance to each electrospinning element 24 is preferably balanced with the electric field strength responsible for extracting the substance from which the fibers are to be composed so that a droplet shape exiting the electrospinning element 24 is maintained constant. In the polymer solutions (or alternatively introduced onto the fibers after or during the electrospinning process) are luminescent compounds. The fibers deposited in the one embodiment of the present invention may range from 50 nm to several microns in diameter.

As in the related application, U.S. Ser. No. 11/130,269, previously incorporated by reference, the present invention can use different electrospinning elements to generate a fiber mat of mixed fibers of different sized fibers. The fiber mat can have for example one side of the mat with a larger average fiber diameter than another side of the fiber mat.

The fibers used in the nanofibers of the present invention include, but are not limited to, acrylonitrile/butadiene copolymer, cellulose, cellulose acetate, chitosan, collagen, DNA, fibrinogen, fibronectin, nylon, poly(acrylic acid), poly(chloro styrene), poly(dimethyl siloxane), poly(ether imide), poly(ether sulfone), poly(alkyl acrylate), poly(ethyl acrylate), poly(ethyl vinyl acetate), poly(ethyl-co-vinyl acetate), poly(ethylene oxide), poly(ethylene terephthalate), poly(lactic acid-co-glycolic acid), poly(methacrylic acid) salt, poly(methyl methacrylate), poly(methyl styrene), poly(styrene sulfonic acid) salt, poly(styrene sulfonyl fluoride), poly(styrene-co-acrylonitrile), poly(styrene-co-butadiene), poly(styrene-co-divinyl benzene), poly(vinyl acetate), polylactides, poly(vinyl alcohol), poly(vinyl chloride), poly(vinylidene fluoride), polyacrylamide, polyacrylonitrile, polyamide, polyaniline, polybenzimidazole, polycaprolactone, polycarbonate, poly(dimethylsiloxane-co-polyethyleneoxide), poly(etheretherketone), polyethylene, polyethyleneimine, polyimide, polyamide, polyisoprene, polylactide, polypropylene, polystyrene, polysulfone, polyurethane, poly(vinylpyrrolidone), proteins, SEBS copolymer, silk, and styrene/isoprene copolymer. Of these materials, fibers from polyurethane, polysulfone, polystyrene, polypropylene, polyisoprene, polyimide, polyethyleneimine, polyethylene, poly(etheretherketone), polybenzimidazole, poly(vinyl chloride), poly(vinyl alcohol), polylactates, poly(vinyl acetate), poly(styrene co-whatever), poly(ether imide), poly(ether sulfone), poly(chloro styrene), acrylonitrile butadiene, cellulose, cellulose aceate, chitosan, collagen, DNA, fibrogen, and fibronectin may have optical transmission properties that restrict the usable wavelengths.

Additionally, nanofibers containing polymer blends can also be produced as long as the two or more polymers are soluble in a common solvent. A few examples would be: poly(vinylidene fluoride)-blend-poly(methyl methacrylate), polystyrene-blend-poly(vinylmethylether), poly(methyl methacrylate)-blend-poly(ethyleneoxide), poly(hydroxypropyl methacrylate)-blend poly(vinylpyrrolidone), poly(hydroxybutyrate)-blend-poly(ethylene oxide), protein blend-polyethyleneoxide, polylactide-blend-polyvinylpyrrolidone, polystyrene-blend-polyester, polyester-blend-poly(hyroxyethyl methacrylate), poly(ethylene oxide)-blend poly(methyl methacrylate), poly(hydroxystyrene)-blend-poly(ethylene oxide)). Of this list poly(methyl methacrylate) or any type of acrylate are fibers particularly suited for the present invention.

Accordingly, given the control provided by the present invention, a long-pass optical filter is created in one embodiment of the present invention using nanofibers of polymers such as poly(methyl methacrylate) (PMMA). These long-pass optical filters have a high extinction coefficient for wavelengths below a passband due to a combination of wavelength-dependent absorption, reflection, and light scattering. Consequently, wavelengths below the passband are attenuated to some extent by the filter. Long-pass optical filters also exhibit a high transmittance (i.e., low extinction coefficient) for wavelengths above the passband, and these wavelengths will be transmitted by the filter with less attenuation.

Films and plaques of PMMA are known to be virtually non-absorbing of visible radiation (see for example information on Plexiglas and Altuglas on the website of Arkema Inc). As a result, PMMA panes are widely used in light fixtures, plastic windows, and other glazing structures. However, in the present invention, optical structures made of PMMA nanofibers can display as much as a 25% change in transmittance across the visible spectrum due to the presence of the nanofibers.

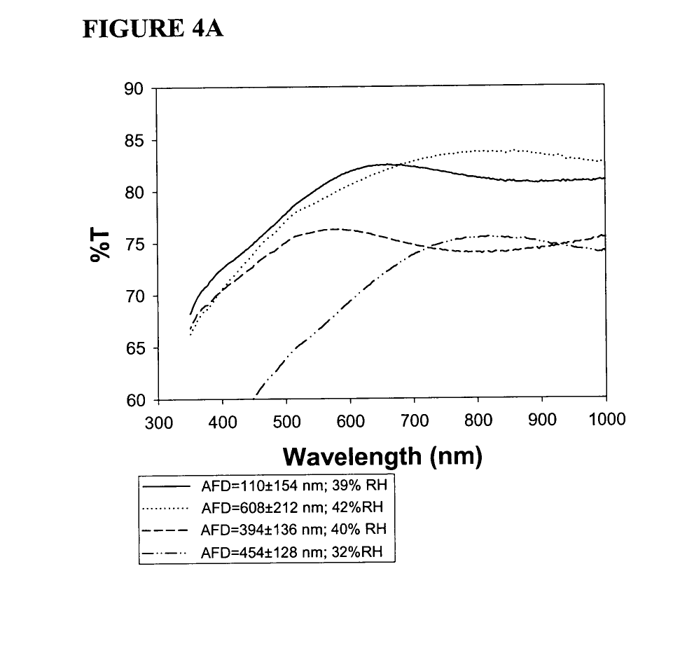

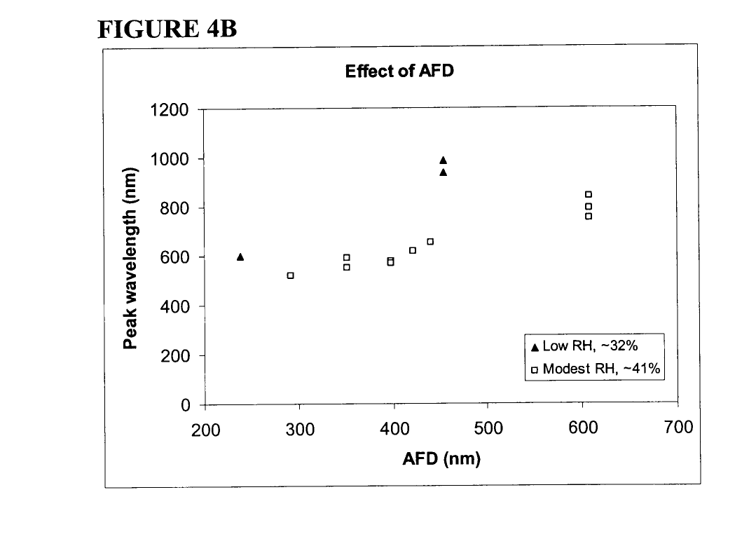

The ability of the PMMA structure to selectively filter optical radiation can be measured by the percentage of light that is transmitted by the structure (% T). FIG. 4A shows the % T for various PMMA nanofiber structures similar to those shown in FIG. 1. More specifically, FIG. 4A shows the percent transmission (% T) of textured (i.e., porous) PMMA nanofiber structures of differing diameters. FIG. 4B is graph, according to one embodiment of the present invention, showing how the peak optical transmission of a nano-fiber based optical element varies with the average fiber diameter and the humidity, which as discussed above influences the fiber distribution. Thus, the cutoff wavelength of the fiber mat varies as a function of the average fiber diameter and the humidity (as well as other factors).

As illustrative of the electrospinning process of the present invention, the following non-limiting example is given to illustrate selection of the polymer, solvent, a gap distance between a tip of the extrusion element and the collection surface, solvent pump rate, and addition of electronegative gases:

a PMMA solution of a molecular weight of 350 kg/mol,

a solvent system consisting of a blend of toluene (70-99% by weight) and N-methyl formamide (1-30% by weight).

an extrusion element tip diameter of 1000 μm,

an Al plate collector,

˜0.5 ml/hr pump rate providing the polymer solution,

an electronegative gas flow of humidity controlled CO₂ at 8 lpm,

an electric field strength of 1.2 KV/cm,

and

a gap distance between the tip of the extrusion element and the collector of 19 cm.

Under these conditions, the resultant optical nanofiber structure exhibits appearances analogous to the optical micrograph shown in FIG. 1. The curves in FIG. 1 are characterized by a region of fairly constant % T at long wavelengths and a sharply declining % T at shorter wavelengths. The wavelength at which the transition from constant % T to rapidly declining % T occurs is termed herein a passband or cutoff wavelength.

Light impinging upon a material is subject to either absorption, reflection, or transmission. Light scattering governs the amount of reflection and transmission that occurs through particle size (relative to wavelength) and other factors. For visible radiation, absorption is determined solely by the chemical composition of the material (i.e., it's electronic structure). For a material such a PMMA that does not absorb appreciably amounts of visible radiation, if light is not transmitted through the structure, then it is reflected by the structure. Thus, the drop in % T shown in FIG. 4A below the cutoff wavelength indicates greater reflectivity at those wavelengths. Both diffuse scattering and reflectivity are accounted for in these measurements as theses measurements were made in an integrating sphere that collects all light transmitted within a 180 degrees. Hence, the nano-fiber optical structures of the present invention can be long-pass filters for wavelengths above the passband.

Alternatively, the nano-fiber optical structures of the present invention can also be reflectors for wavelengths below the passband. For example, the curve in FIG. 4A with a cutoff wavelength of roughly 525 nm can be used as a long pass filter for wavelengths above 525 nm. It can also be used as a reflector for wavelengths below 525 nm, and is a wavelength-dependent reflector. This differs from a metal reflector, which generally reflects all wavelengths equally.

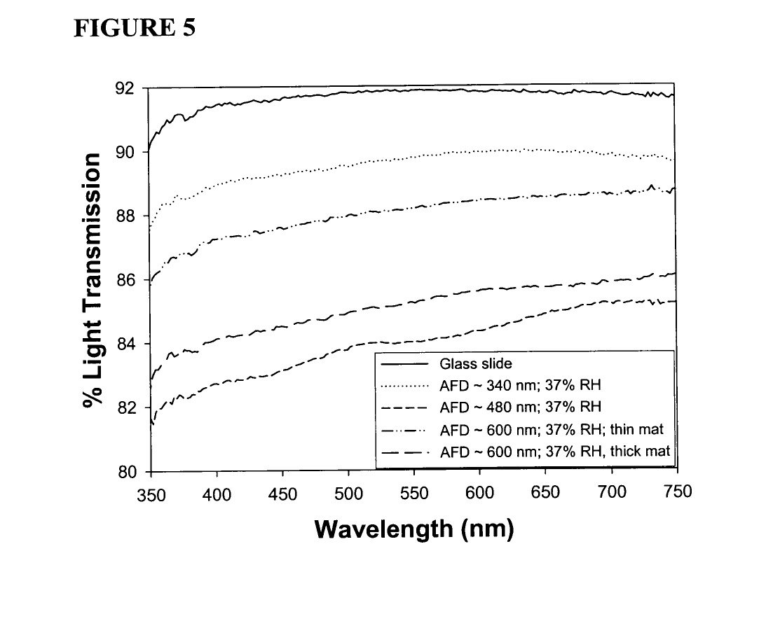

In one embodiment of the present invention, random, textured (i.e., porous) nanofibers are the most effective for use as optical filters and wavelength selective reflectors, as discussed above. In contrast, smooth round nanofibers have been found to be poor scatterers of lights and are not as effective for either use. Typical % T data observed from smooth nanofibers are given in FIG. 5. More specifically, FIG. 5 shows the percent transmission (% T) of smooth, round PMMA nanofiber structures of differing diameters.

Thus, the morphology of both the individual nanofibers and the assembled nanofiber structure are important in determining the properties of the optical filters. For example, smooth nanofibers have to date been found to produce only small variations in light extinction between long wavelengths (>500 nm) and short wavelengths (<500 nm). Hence, these structures would make relatively poor long-pass filters. However, some porous nanofibers have been shown to produce as much as a 25% drop in % transmission between 350 nm and 750 nm.

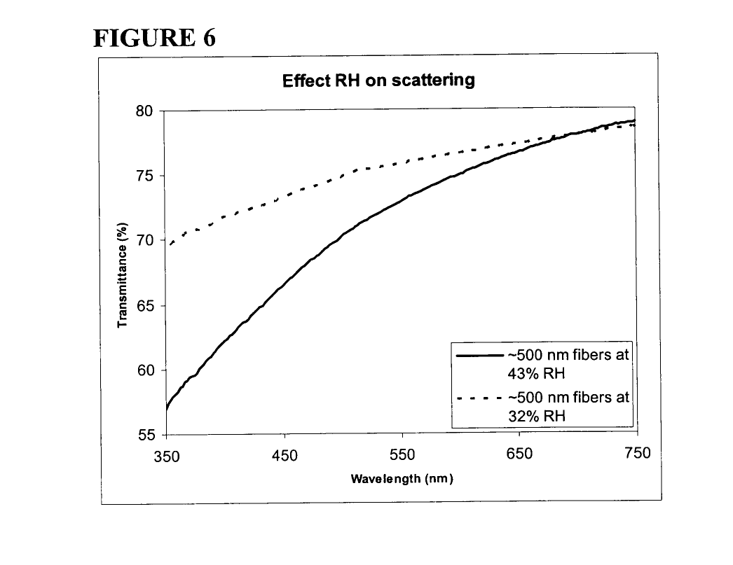

The arrangement of the nanofibers within the optical structure has been found to be very important in determining optical filter performance with structures having small, relatively uniforms spaces between nanofibers exhibit the largest changes in % transmission across the optical spectrum. By example, 8.2 wt % PMMA in toluene with 8.2 wt % MF was electrospun using conditions described above. Relative humidity was either 32% RH or 42% RH. Marked difference in scatter at lower wavelength (<550 nm) were observed as shown in FIG. 6. FIG. 6 illustrates an effect that relative humidity has on the resultant optical scatter. For these, nominally 500 nm diameter fibers, the fibers produced under a relative humidity of 42% had substantially more scatter due to good dispersion of fibers and lack of agglomeration, such as shown in FIG. 1A.

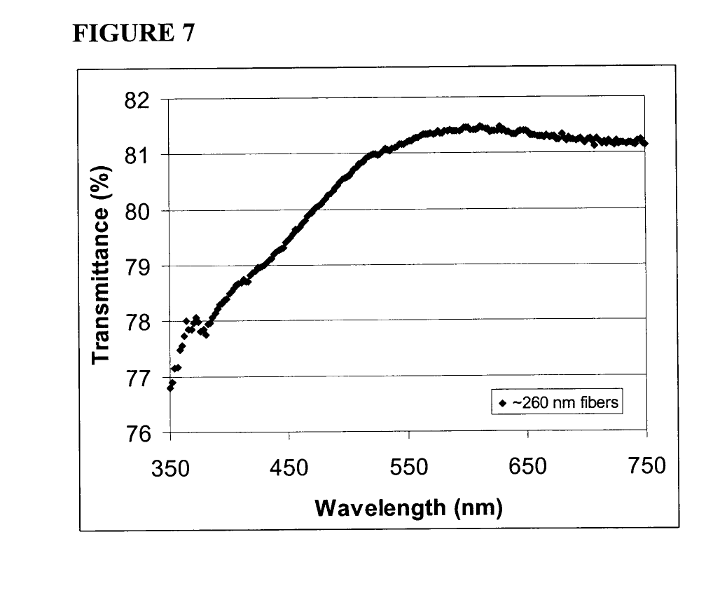

In some cases, a change in % T is accompanied by a region of relatively flat % transmission, which is desirable for performance as an optical filter. Using similar electrospinning conditions as the previous example, but 8 wt % PMMA and 8 wt % MF, and a dry humidity (<32%) a mat was deposited with the scattering curve shown in FIG. 7. The use of this type of optical nanofiber structures permits, according to the present invention, the creation of an optical structure that has a high transmittance to wavelengths above about 550 nm and then scatters short wavelengths.

The average fiber diameter for the optical filter of the present invention is in a range between 100 to 2000 nm, or more suitably between 200 nm to 1000 nm, or more suitably between 300 nm to 800 nm. The average fiber diameter is in a range of 0.50 to 1.50 of the wavelength λ, or more suitably in a range of 0.9 to 1.10 of the wavelength λ. The wavelength λ is in a range between 100 and 2000 nanometers, or more suitably between 400 and 500 nanometers. The optical filter has a thickness in a range between 0.1 and 2,000 microns, or more suitably in a range between 1 to 10 microns.

While not limited to any particular theory, light scattered from the fibers in the optical filter depends on the fiber diameter, light wavelength, orientation of the fiber to the light, the refractive index of the fibers, and the refractive index of the medium the fibers are in. In the examples above the medium was air, but the invention is not restricted to air. The fibers could be filled with a liquid medium (e.g., an oil) or filled with another polymer changing the refractive index of the medium depending on the known index of the medium chosen. Polymers of the fibers have real refractive indices in the range between 1.3 to 1.6. Examples of the light scattering efficiency curves for long fibers of slightly absorbing materials (and which may act in a similar manner as the nanofiber structures of the present invention) have been detailed previously by Van de Hulst, in Light Scattering by Small particles, Dover, 1957.

In that earlier work, for an incident light of 300 nm, the maximum light scattering has a size parameter (π times fiber diameter/wavelength) of 3.14 and a scattering efficiency (Q) of Q₁=4.2. For incident light at 600 nm, the size parameter is 1.6 and Q₁=2. Therefore, the shorter wavelength is twice as likely of being scattered in the optical element than the longer wavelength light. An alternative explanation of this phenomenon is that, on average, the optical path length (OPL) of light at 400 nm through an appropriately designed optical is longer than the OPL of 600 nm light.

The implications of this phenomena as applied to the present invention are that the light scattering characteristics of the fibers in the optical filter is that, for each fiber acting as a scattering center, the mat of fibers act as a medium which more effectively scatters light permitting a higher probability that shorter wavelength light will be scattered in what would normally be expected to be a transparent medium.

In one embodiment of the present invention, the optical element includes a number of nanofibers layers. The nanofibers of these layers serve individually as scattering centers for the incident light. Typically, the nanofibers have an average diameter that is approximately from 200-500 nm. Furthermore, the number of layers in the optical element typically form a thickness for the optical element in a range of 0.1 to 2,000 microns, although thinner values such as for example 0.01 microns and thicker values such as for example 3,000 microns are suitable. The thinner layers may not be as likely to “scatter” the shorter wavelength light below the cutoff value. The thicker layers may not transmit the longer wavelength light as well as the thinner layers.

In one embodiment of the present invention, the optical element includes a number of nanofibers layers. The nanofibers of these layers serve individually as scattering centers for the incident light. Typically, the nanofibers have an average diameter that is approximately from 100 to 2000 nm, or more suitable between 300 and 1000 nm, or more suitable between 400 and 800 nm, as results for 700 nm fibers exemplify the optical filter cutoff characteristics discussed herein.

Furthermore, the number of layers in the optical element typically forms a thickness for the optical element in a range of 0.1 to 2,000 microns, although thinner values such as for example 0.01 microns and thicker values such as for example 3,000 microns are suitable. The thinner layers may not be as likely to “scatter” the shorter wavelength light below the cutoff value. The thicker layers may not transmit the longer wavelength light as well as the thinner layers.

This invention is compatible with standard polymer processes and can be readily integrated with plastics manufacturing. In particular, this technology can be incorporated into solid-state lighting (SSL) devices. It is anticipated that this structure will improve the efficiency of phosphor-converted light emitting diodes (pc-LED) used in SSL by providing preferential light scattering of the excitation wavelength λₑₓ. Since the scattering efficiency of λₑₓ is high, the pump wavelength can be confined around the phosphors and the likelihood of λₑₓ being converted by the phosphors into visible light is increased. Eliminating the bleed-through of the pump excitation will increase efficiency and permit lower CCT temperatures such as “warm white” that are more conducive to general illumination.

Other applications of the present invention include window treatments, helmet face shields, and optical elements. In window treatment applications, the optical filter elements of the present invention would generally filter out harmful radiation such as UV. Likewise for helmet faceshield applications. Additionally, the addition of the nanofibers to the plastic faceshields would impart reflectivity of UV wavelengths.

These optical fibers in mat form can also be used in building materials.

Numerous modifications and variations on the present invention are possible in light of the above teachings. It is, therefore, to be understood that within the scope of the accompanying claims, the invention may be practiced otherwise than as specifically described herein.

1. An optical device comprising:
a mat comprising plural nanofibers configured to transmit light having wavelengths above a cutoff wavelength and to reject light at wavelengths below said cutoff wavelength; and
said nanofibers having an average fiber diameter comparable in size to the cutoff wavelength.

2. The optical device of claim 1, wherein said nanofibers having an average fiber diameter in a range between 100 and 2000 nm.

3. The device of claim 1, wherein the nanofibers have an average fiber diameter of less than 800 nm, of less than 500, or of less than 300 nm.

4. The device of claim 1, wherein the mat comprises between 4 to 4000 layers or between 10 to 100 layers of the nanofibers.

5. The device of claim 1, wherein the mat comprises a thickness between 0.25 and 2,000 μm.

6. The device of claim 1, wherein the average fiber diameter is in a range between 200 to 800 nm or between 300 nm to 500 nm.

7. The device of claim 1, wherein the average fiber diameter is in a range of 0.50 to 1.50 of the cutoff wavelength λ.

8. The device of claim 7, wherein the average fiber diameter is in a range of 0.9 to 1.10 of the cutoff wavelength λ.

9. The device of claim 1, wherein the cutoff wavelength λ is in a range between 200 and 600 nanometers.

10. The device of claim 9, wherein the cutoff wavelength λ is in a range between 300 and 500 nanometers.

11. The device of claim 1, wherein the average fiber diameter is in a range of 0.9 to 1.10 of the cutoff wavelength λ.

12. The device of claim 1, wherein the cutoff wavelength λ is in a range between 300 and 600 nanometers.

13. The device of claim 12, wherein the cutoff wavelength λ is in a range between 400 and 500 nanometers.

14. The device of claim 1, wherein the nanofibers comprise polymers including at least one of poly(alkyl acrylate), poly(methyl methacrylate), poly(ethylene oxide), polystyrene, polysulfone, polylactides, polycarbonate, polyamides, poly(vinyl alcohol), derivatives thereof and related polymers, polysilicones, polysulfones, and combinations thereof.

15. The device of claim 1, wherein the nanofibers comprise polymers including of at least one poly(methyl methacrylate) and related acrylates, and combinations thereof.

16. The device of claim 1, wherein the nanofibers include additives to alter at a refractive of the nanofibers in the fiber mat.

17. The device of claim 1, wherein the mat comprises a wavelength dependent reflector that reflects light below the cutoff wavelength and passes light above the cutoff wavelength.

18. The device of claim 1, wherein the mat comprises a filter for a lighting unit.

19. The device of claim 18, wherein the lighting unit comprises a solid-state lighting unit.

20. The device of claim 1, wherein the mat comprises a wavelength dependent reflector for a lighting unit.

21. The device of claim 20, wherein the lighting unit comprises a solid-state lighting unit.

22. The device of claim 1, wherein the mat comprises a reflector for a window unit.

23. The device of claim 1, wherein the mat comprises a building component.

24. An optical filter comprising:
a mat of nanofibers having an average fiber diameter comparable in size to a cutoff wavelength,
wherein the mat of the nanofibers transmits light above a cutoff wavelength and rejects light below that wavelength.

25. A wavelength dependent reflector comprising:
a mat of nanofibers having an average fiber diameter comparable in size to a cutoff wavelength,
wherein the mat of the nanofibers reflects light below the cutoff wavelength and passes light above the cutoff wavelength.
